(19) United States
(12) Patent Application Publication
(10) Pub. No.: US 2020/0110288 A1
(43) Pub. Date: Apr. 9, 2020

(54) PRESCRIPTION LENS BLANK STRUCTURE

(71) Applicant: Hwa Meei Optical Co.,Ltd., Tainan City (TW)

(72) Inventors: Chin Ming Chen, Tainan (TW); Nan Huag Kuo, Tainan (TW)

(21) Appl. No.: 16/221,556

(22) Filed: Dec. 16, 2018

(30) Foreign Application Priority Data
Oct. 9, 2018 (TW) 107135516

(51) Int. Cl. G02C 7/10

(52) U.S. Cl. CPC G02C 7/108; B29D 11/00403; G02C 2202/08

(57) ABSTRACT

Provided is an prescription lens blank structure, including a first lens having a predetermined color and including a first outer surface and a first inner surface; and a second lens being a transparent lens and including a second outer surface and a second inner surface. The second outer surface of the second lens is directly combined with the first inner surface of the first lens in a mold, or the first inner surface of the first lens is directly combined with the second outer surface of the second lens in the mold, so as to form a prescription lens blank.

### BACKGROUND OF THE INVENTION

### 1. Field of the Invention

The present disclosure relates to a lens blank, and particularly relates to a prescription lens blank structure.

### 2. The Prior Arts

Generally, in the production of materials of flat-light sunglasses lenses, the material of a polyamide (PA) or a polycarbonate (PC) and dyes are pre-mixed and granulated, and then the flat-light sunglasses lenses are produced with a uniform thickness and having a filtering ability are produced by injection or casting.

It a prescription sunglasses lens is produced in the same way, the curvature of the lens will cause a large difference in the thickness between the center and the edge of the lens. Therefore, the filtering effects of the center and the edge of the lens will be different and the color of the lens will be different. Not only the appearance of the lens is not beautiful, but also the user feels bad when wearing this lens to view the scene.

According to the prior art, a prescription sunglasses lens are mostly made after forming the shape of the prescription sunglasses lens. Subsequently, the dyeing process is performed on the surface of the lens by dipping or spraying. Such method makes the effect of dyeing the lens less uneven, and the long-term outdoor weather resistance is also poor. In addition, poor-quality dyes may fade to the user's clothing or hands, and the management of the processing labs for prescription lenses is more complicated. Therefore, how to provide a better prescription lens blank structure is one of the current important issues.

### SUMMARY OF THE INVENTION

In order to achieve the above objective, according to a preferred embodiment, the present disclosure provides a prescription lens blank structure, including a first lens, having a predetermined color and including a first outer surface and a first inner surface; and a second lens, being a transparent lens and including a second outer surface and a second inner surface, wherein the second outer surface of the second lens is directly combined with the first inner surface of the first lens in a mold, or the first inner surface of the first lens is directly combined with the second outer surface of the second lens in the mold, so as to form a prescription lens blank.

Preferably, the first outer surface of the first lens is opposite the first inner surface of the first lens.

Preferably, a thickness of the first lens is between 0.5 mm and 2 mm.

Preferably, a thickness of the second lens is between 5 mm and 15 mm.

Preferably, the material of the first lens is a material obtained by pre-mixing and granulating a polyamide (PA) or a polycarbonate (PC) and a dye, or a material obtained by mixing the dye and a raw material.

Preferably, the material of the second lens is a polyamide material or a polycarbonate material.

Preferably, the second outer surface of the second lens is combined with the first inner surface of the first lens by a casting, injection or extrusion method.

### BRIEF DESCRIPTION OF THE DRAWINGS

FIG. 1 shows a schematic cross-sectional view of a prescription lens blank structure according to an embodiment of the present disclosure.

FIG. 2 shows a schematic cross-sectional view of a prescription lens blank structure according to another embodiment of the present disclosure.

### DETAILED DESCRIPTION OF THE PREFERRED EMBODIMENT

The detailed description of the present disclosure is provided in combination with the accompanying drawings.

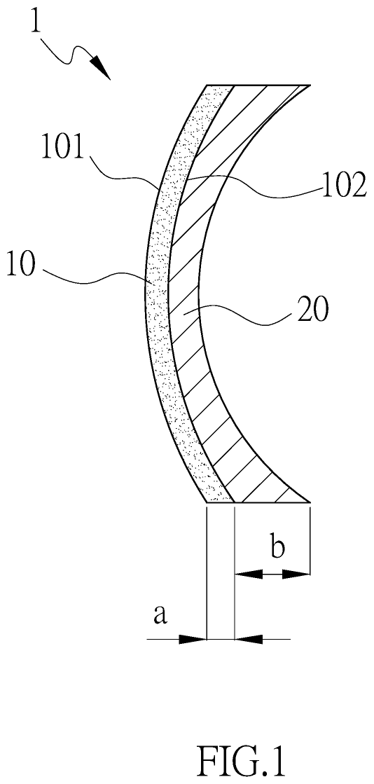

According to the present disclosure, FIG. 1 shows a prescription lens blank structure including a first lens 10 and a second lens 20.

As shown in FIG. 1, the first lens 10 of the present disclosure has a predetermined color, and includes a first outer surface 101 and a first inner surface 102. It is worth mentioning that the first outer surface 101 of the first lens 10 is opposite the first inner surface 102 of the first lens 10.

Moreover, referring to FIG. 1, the second lens 20 of the present disclosure is a transparent lens, and includes a second outer surface 201 and a second inner surface 202.

The second outer surface 201 of the second lens 20 may be directly combined with the first inner surface 102 of the first lens 10 in a mold (not shown), so as to form a prescription lens blank 1, as shown in FIG. 1.

Specifically, according to the present disclosure, the prescription lens blank can be made by combining two different lenses, in order to overcome the problems caused by the prior art. The first molded lens is a lens semi-finished product (which may be the first lens 10) with a color layer. The material of the first molded lens is a color pigment, and after mixing, a lens blank semi-finished product with a uniform thickness is formed. The thickness a of the first lens blank semi-finished product is 1.5 mm. In addition, if it is necessary to include a polarizing lens, a polarizing layer may be added to the first molding.

Subsequently, the first molded semi-finished product (which may be the first lens 10) is placed in a second molding die, and a polycarbonate (PC) is used as an example (also combined with a different material). The second lens 20 (which may be a transparent layer) having a thickness b of 7.5 mm is combined with the first lens 10 directly in the mold to form a prescription sunglasses lens blank structure. However, this is not intended to limit the molding sequences of the present disclosure.

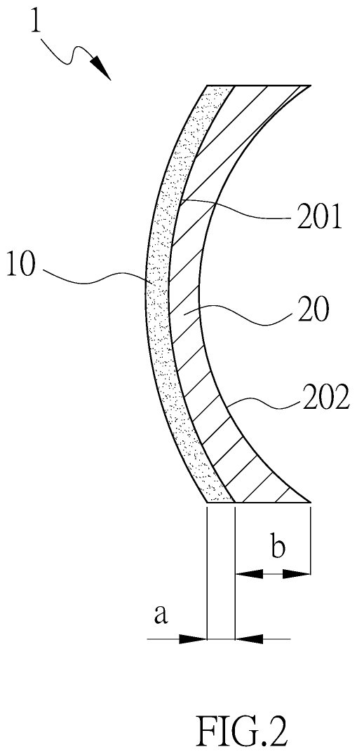

FIG. 2 shows a schematic cross-sectional view of a prescription lens blank structure according to another embodiment of the present disclosure. This embodiment is different from the above embodiment as follows. The second lens 20 includes a second outer surface 201 and a second inner surface 202. The material of the first molded lens is a transparent material having a thickness b between 5 mm and 15 mm, and then the semi-finished product (which may be the second lens 20) is placed in a second molding die, and the raw material may be pre-mixed with a polyamide (PA) or polycarbonate (PC) material and a color pigment. The material after the granulation or mixed with the dye and the raw material is molded into the first lens 10 having a thickness a of 0.5 mm to 2 mm (which may be a uniform color layer), and is combined with the second outer surface 201 of the second lens 20 in the mold, so as to form a prescription sunglasses lens blank. In addition, if it is necessary to include a polarizing lens, a polarizing layer may be added to the second molding.

To sum up, the prescription lens blank structure of the present disclosure can effectively solve the problems caused by the prior art. As shown in FIG. 1, when the lens with degree is produced, only the second lens 20 (i.e., the transparent layer) needs to be ground according to the degree required by the user. That is, the second lens 20 can be processed and ground to produce the required degree, and the first lens 10 has the same thickness and uniform color. Therefore, the first lens 10 does not have the problem of color unevenness, and the user will not have chromatic aberration when using.

Although the present disclosure has been described with reference to the preferred exemplary preferred embodiments thereof, it is apparent to those skilled in the art that a variety of modifications and changes may be made without departing from the scope of the present disclosure which is intended to be defined by the appended claims.

What is claimed is:

1. A prescription lens blank structure, comprising:
a first lens, having a predetermined color and including a first outer surface and a first inner surface; and
a second lens, being a transparent lens and including a second outer surface and a second inner surface,
wherein the second outer surface of the second lens is directly combined with the first inner surface of the first lens in a mold, or the first inner surface of the first lens is directly combined with the second outer surface of the second lens in the mold, so as to form a prescription lens blank.

2. The prescription lens blank structure of claim 1, wherein the first outer surface of the first lens is opposite the first inner surface of the first lens.

3. The prescription lens blank structure of claim 1, wherein a thickness of the first lens is between 0.5 mm and 2 mm.

4. The prescription lens blank structure of claim 1, wherein a thickness of the second lens is between 5 mm and 15 mm.

5. The prescription lens blank structure of claim 1, wherein the material of the first lens is a material obtained by pre-mixing and granulating a polyamide (PA) or a polycarbonate (PC) and a dye, or a material obtained by mixing the dye and a raw material.

6. The prescription lens blank structure of claim 1, wherein the second outer surface of the second lens is combined with the first inner surface of the first lens by a casting, injection or extrusion method.

7. A prescription lens blank structure, comprising:
a first lens, having a predetermined color and including a first outer surface and a first inner surface; and
a second lens, being a transparent lens and including a second outer surface and a second inner surface,
wherein the first inner surface of the first lens is directly combined with the second outer surface of the second lens in a mold, so as to form a prescription lens blank.

8. The prescription lens blank structure of claim 7, wherein the first outer surface of the first lens is opposite the first inner surface of the first lens.

9. The prescription lens blank structure of clam 7, wherein a thickness of the first lens is between 0.5 mm and 2 mm.

10. The prescription lens blank structure of claim 7, wherein a thickness of the second lens is between 5 mm and 15 mm.
